(19) United States
(12) Patent Application Publication
(10) Pub. No.: US 2007/0205271 A1
(43) Pub. Date: Sep. 6, 2007

(54) Method and apparatus for automated teller machine transactions

(75) Inventors: Sonia Monica Gaillard, Austin, TX (US); Nia Letise Kelley, Austin, TX (US); Kimberly DaShawn Simon, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation

(21) Appl. No.: 11/366,668

(22) Filed: Mar. 2, 2006

(51) Int. Cl. G06F 7/08; G07F 19/00

(52) U.S. Cl. 235/381; 235/379

(57) ABSTRACT

The present invention provides a computer implemented method, apparatus, and computer usable program code to receive a request to withdraw money using a bank card. A determination is made as to whether a profile is present on the bank card. The money is dispensed using types of currency based on the profile in response to the determination that the profile is present on the bank card.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for processing financial transactions.

2. Description of the Related Art

Automated teller machines (ATMs) are commonly used by people to perform financial transactions. Most often, automated teller machines are used to withdraw money from a user account. Automated teller machines also may be used to make deposits to a user or customer account.

Often times, when withdrawing money from an automated teller machine, a user does not have the ability to indicate the increments in which the money is to be received. For example, if a user uses an automated teller machine to withdraw one hundred dollars from the user's account, an option to indicate the manner in which the one hundred dollars in to be withdrawn is hardly ever presented. For example, the user is not provided with an option to withdraw the money as a single one hundred dollar bill, five twenty dollar bills, or a mix of bills and coins.

Some automated teller machines do provide an option for a user to indicate the manner in which money is to be withdrawn. These options, however, are not readily available at many automated teller machines. As a result, the user is required to receive the money using the types of currency specified by the process or program used by the automated teller machine.

### SUMMARY OF THE INVENTION

The present invention provides a computer implemented method, apparatus, and computer usable program code to receive a request to withdraw money using a bank card. A determination is made as to whether a profile is present on the bank card. The money is dispensed using types of currency based on the profile in response to the determination that the profile is present on the bank card.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a diagram illustrating an automated teller machine in accordance with an illustrative embodiment of the present invention;

FIG. 4 is a diagram illustrating components used in performing automated teller machine transactions in accordance with an illustrative embodiment of the present invention;

FIG. 5 is a diagram illustrating an electronic user preference profile in accordance with an illustrative embodiment of the present invention;

FIG. 6 is a flowchart of a process for generating an electronic user preference profile in accordance with an illustrative embodiment of the present invention;

FIGS. 7A-7B are a flowchart of a process for processing a financial transaction at an automated teller machine in accordance with an illustrative embodiment of the present invention; and

FIG. 8 is a flowchart of a process for creating dynamic records in accordance with an illustrative embodiment of the present invention.

### DETAILED DESCRIPTION OF THE PREFERRED EMBODIMENT

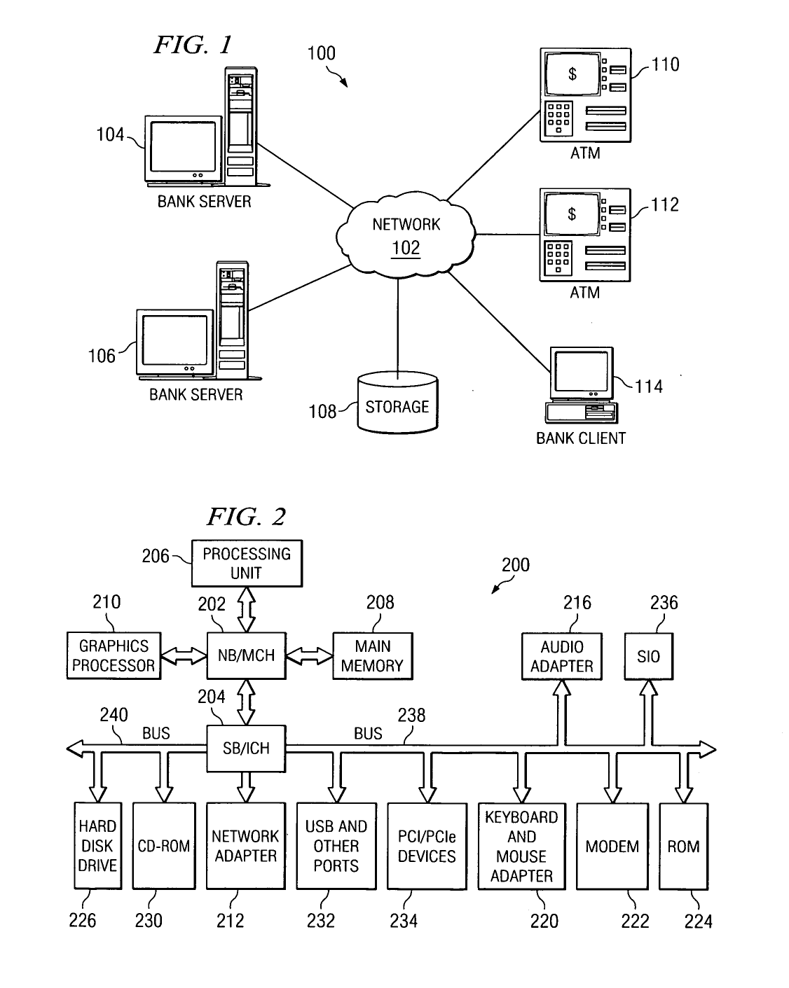

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, bank server 104 and bank server 106 connect to network 102 along with storage unit 108. In addition, automated teller machine (ATM) 110, automated teller machine 112, and bank client 114 connect to network 102. Bank client 114 may be, for example, a personal computer or a network computer. In the depicted example, bank server 104 provides data, such as boot files, operating system images, and applications to automated teller machine 110, automated teller machine 112, and bank client 114. Automated teller machine 110, automated teller machine 112, and bank client 114 are clients to bank server 104 in this example. In particular, bank server 104 communicates with automated teller machines 110 and 112 to perform financial transactions. These financial transactions may include withdrawal or deposit of funds from a bank. Of course, bank server 106 may be a server for any type of financial institution other than just a typical bank. For example, bank server 106 may be a server for a financial institution, such as, for example, a savings and loan or a brokerage company. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). For example, network 102 may be a local area network located within a building of a bank. FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as bank server 104 or bank client 114 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

Hard disk drive 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. For example, bank client 114 in FIG. 1 may be a personal digital assistant used to perform different transactions at a financial institution. These transactions may include, for example, viewing account information, moving funds from one account to another account, or initiating a wire transfer of funds to a destination or target account.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 in FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

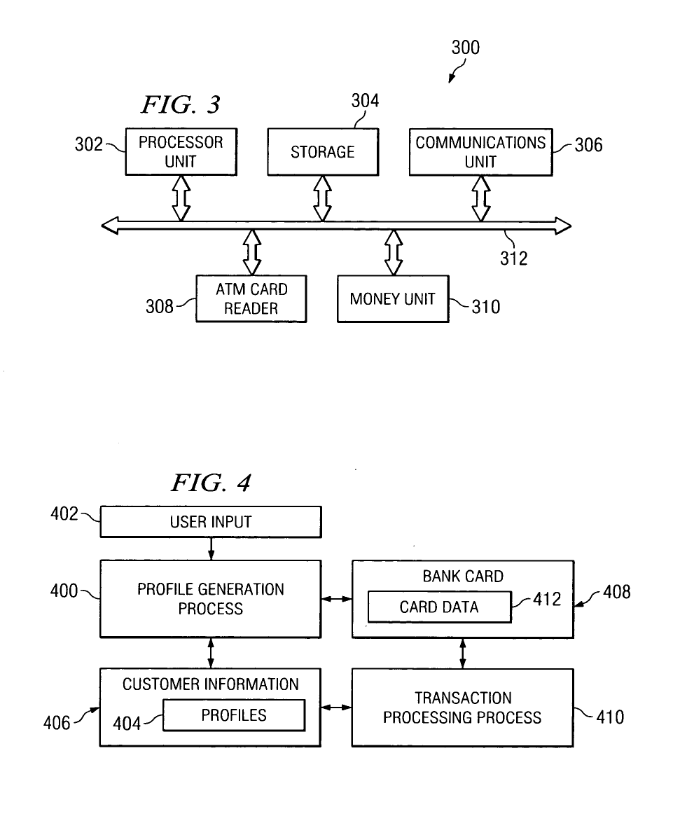

Turning next to FIG. 3, a diagram illustrating an automated teller machine is depicted in accordance with an illustrative embodiment of the present invention. In this example, automated teller machine 300 may be, for example, automated teller machine 110 or 112 in FIG. 1.

In this illustrative example, automated teller machine 300 contains processor unit 302, storage 304, communications unit 306, automated teller machine (ATM) card reader 308, and money unit 310. All of these components are interconnected through bus 312. This bus may take various forms depending on the particular implementation. Bus 312 may be implemented using any type of communications fabric or architecture that provides for a transfer of data between different components or devices attached to bus 312.

Processor unit 302 executes instructions that may be stored in storage 304. These instructions are executed to perform various financial transactions for the user of automated teller machine 300. For example, the instructions may be executed to deposit money, withdraw money, or obtain account information in these examples. Storage 304 may take various forms. For example, storage 304 may be a memory, a combination of a memory and a hard drive or some other combination of devices that store data and instructions depending on the particular implementation. Communications unit 306 provides a connection to a network to facilitate financial transactions with a server or other end points for the financial institution.

Automated teller machine card reader 308 is a functional unit that includes a device to read an automated teller machine card. In these examples, the automated teller machine card contains a magnetic strip to store data. Of course, the automated teller machine card may take other forms. For example, the card may contain integrated circuit chips that provide the information needed to perform financial transactions.

Alternatively, the automated teller machine card also may take the form of a key fob and may include biometric solutions needed to access the information on the particular card or device. Money unit 310 includes any device that holds money as well as a mechanism to dispense the money when a financial transaction takes the form of a withdrawal from a user's account. Money unit 310 is controlled by bus 312 executing instructions that may be stored within storage 304. Automated teller machine card reader 308 reads the data from the automated teller machine card to initiate and perform financial transactions.

The aspects of the present invention provide a computer implemented method, apparatus, and computer usable program code for facilitating the withdrawal of funds from an account. In particular, the aspects of the present invention allow a user to specify the types of currency for the withdrawal. This specification of the currency is identified through a profile that is present on a banking card, such as an automated teller machine card. The aspects of the present invention employ an electronic user preference (EUP) profile that is stored on the automated teller machine card. In these examples, the profile is stored in the magnetic barcode or strip on the card. An electronic user preference profile is a data structure that contains information on a preferred method of conducting various financial transactions for a particular user.

In these examples, the transactions are for different automated teller machine transactions. This information also may be stored on other types of banking cards or devices, such as a smart card with integrated circuits, key fob, and other devices. In these illustrative examples, the electronic user preference profile has an initial set of transaction preferences that are stored within the profile. These preferences are defined by a user and are stored on the bank card when the user is first issued a card or when an electronic user preference profile is first generated for a particular bank card.

The aspects of the present invention maintain a copy of currency types used in typical cash withdrawals in the electronic user preference profile. In this manner, if an automated teller machine has an interface that allows a user to indicate the types of currency for a cash withdrawal, the selections made by the user are stored in the electronic user preference profile. As a result, new or different preferences for types of currency may be stored to maintain an updated set of preferences for a user.

The electronic user preference profile serves also as a data structure to store information about financial transactions. In particular, in these examples, the financial transactions are for cash withdrawals from an automated teller machine. In these illustrative examples, the electronic user preference profile contains a static master record and a set of dynamic records. Depending on the particular implementation, the electronic user preference profile may have a predefined number of dynamic records that may be populated at a later time. These unpopulated dynamic records are referred to as skeleton records and contain fields that have not been filled in with particular data. These fields may be filled in later as a user makes transactions in which the user indicates different types of currency for use in withdrawing money from the user's account.

Turning now to FIG. 4, a diagram illustrating components used in performing automated teller machine transactions is depicted in accordance with an illustrative embodiment of the present invention. In this example, profile generation process 400 is employed to receive user input 402. This user input contains information about preferences for types of currency used to withdraw money from a user's account. User input 402 may contain preferences about how money is to be withdrawn for different withdrawal amounts.

Additionally, this input also may indicate secondary preferences for types of currency as to how money is to be withdrawn if the first preference cannot be met for types of currency specified for withdrawing cash for a particular amount of money. User input 402 is used by profile generation process 400 to generate a profile that is stored in profiles 404 as part of customer information 406. Customer information 406 is typically stored by a financial institution for use in handling user transactions. In these examples, customer information 406 with profiles 404 may be stored at bank server 104 in FIG. 1. Alternatively, this information may be stored in storage 108 in FIG. 1 for access. The customer information may include other information about a customer, such as, for example, the user name, address, phone number, bank account number, and other information about the particular user.

Profile generation process 400 also generates an electronic user preference profile that is stored within card data 412 in bank card 408. In these examples, this card data includes information, such as an account number and a user name, along with the electronic user preference profile. After the electronic user preference profile has been stored in card data 412, bank card 408 may be used to withdraw money in a manner that allows withdrawals to be made using preferences for particular types of currency based on withdrawal amounts when bank card 408 is used at an automated teller machine. In this example, transaction processing process 410 is software executed by an automated teller machine, such as automated teller machine 300 in FIG. 3. Alternatively, this software may be executed at a remote computer with the automated teller machine receiving data to display instructions or commands as to how much money to dispense.

Transaction processing process 410 includes processes for facilitating the withdrawal of money from a user account. This process provides the necessary communication with the financial institution as well as identifying the electronic user preference profile and applying that profile in facilitating a withdrawal of money from the automated teller machine. Transaction processing process 410 identifies the amount of money to be withdrawn based on a user input at the automated teller machine.

Based on this amount in the user input, transaction processing process 410 examines the electronic user preference profile in card data 412 to determine whether a preference is present for the particular amount entered by the user. If a preference is present, transaction processing process 410 determines whether the types of currency specified by the preference are present within the automated teller machine to satisfy that preference. If the types of currency are present, then the currency is dispensed using the preference identified for the particular amount. Otherwise, a secondary preference may be identified or a default type of currency or types of currency may be used to dispense the cash for the user withdrawal.

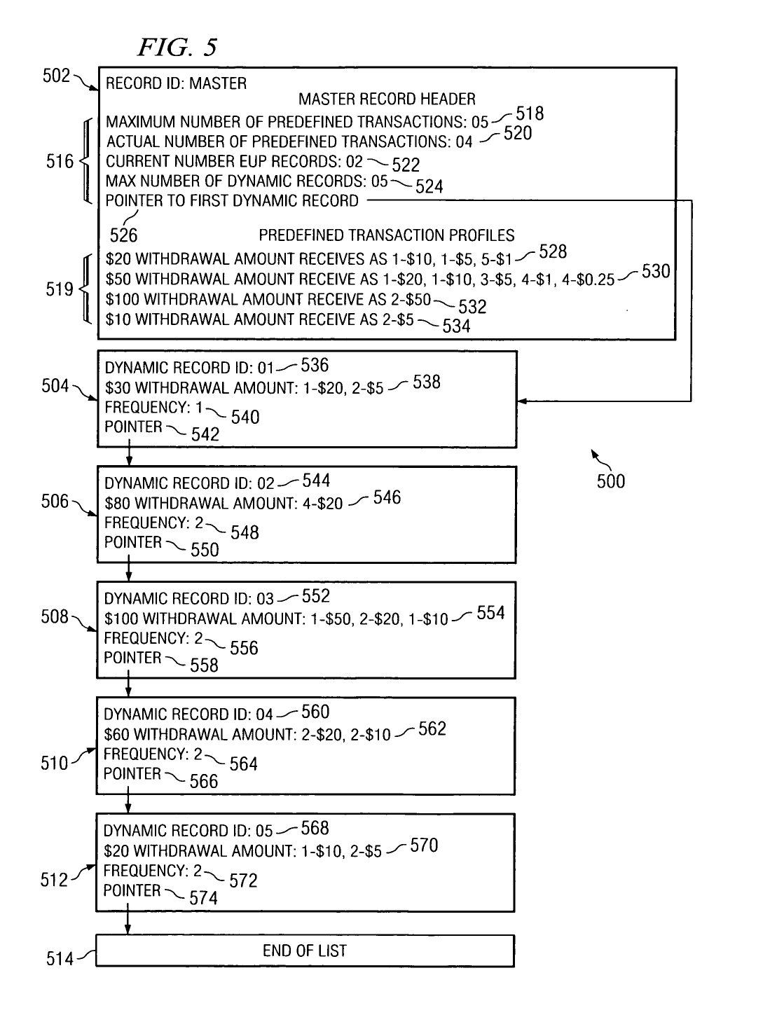

Turning now to FIG. 5, a diagram illustrating an electronic user preference profile is depicted in accordance with an illustrative embodiment of the present invention. In this illustrative example, electronic user preference profile 500 contains two types of records: master record 502 and dynamic records 504, 506, 508, 510, and 512. As can be seen, each record has a pointer to a subsequent record with the last record having a pointer indicating that end of list 514 has been reached.

Master record 502 is typically established by a user and is typically a read only object. In this example, master record 502 contains header 516. The information in header 516 includes maximum number of predefined transactions 518, actual number of predefined transactions 520, current number of electronic user preference profile records 522, maximum number of dynamic records 524, and pointer to first dynamic record 526.

Maximum number of predefined transactions 518 indicates the maximum number of predefined transactions that may be present within master record 502. In this example, the value for maximum number of predefined transactions 518 is 5. Actual number of predefined transactions 520 identifies the actual number of predefined transactions within predefined transaction profiles 519. Current number of electronic user preference profile records 522 identifies the current number of populated EUP Records. In this example, 2 records are populated. For example, if the system is designed to support a maximum of 5 records and 2 records are currently populated, then the program will know that there are 3 records left that can be used to store new profiles. Maximum number of dynamic records 524 indicates the maximum number of dynamic records that may be part of the electronic preference user profile. In this example, the maximum number of records is 5. Pointer to first dynamic record 526 is a pointer to the first dynamic record within electronic user preference profile 500. In this example, this record is dynamic record 504. In these examples, actual number of predefined transactions 520 has a value of 4 as can be seen in predefined transaction profiles 519.

In this depicted example, predefined transactions are for different amounts of withdrawals. Predefined transaction 528 indicates that a withdrawal amount of twenty dollars should be received using the types of currency as follows: 1 ten dollar bill, 1 five dollar bill, and 5 one dollar bills. Predefined transaction 530 indicates that a fifty dollar withdrawal amount should be received as 1 twenty dollar bill, 1 ten dollar bill, 3 five dollar bills, 4 one dollar bills, and 4 quarters. Predefined transaction 532 indicates that a withdrawal amount of one hundred dollars should be received using the types of currency as follows: 2 fifty dollar bills. Predefined transaction 534 indicates that a ten dollar withdrawal amount should be received as 2 five dollar bills. In these examples, the “types of currency” specifies one or more currencies for use in withdrawal. As can be seen, these preferences allow a user to predefine different currency types for use in withdrawing money from an account at an automated teller machine.

In these examples, dynamic records 504, 506, 508, 510, and 512 are populated as a user makes cash withdrawals not defined within predefined transaction profiles 519 and master record 502. Initially, each of these dynamic records or “skeleton records” contain fields for the different withdrawal amounts, but do not have the actual information until identified through user transactions.

In this example, each dynamic record contains a dynamic record identifier, a transaction preference, a frequency, and a pointer to a next entry. Dynamic record 504 is the first dynamic record as indicated by dynamic record ID 536. Transaction preference 538 is for a thirty dollar withdrawal amount in which the withdrawal is made using 1 twenty dollar bill and 2 five dollar bills. Frequency 540 indicates that this type of withdrawal has been performed once for the user. Pointer 542 points to dynamic record 506.

In dynamic record 506, dynamic record ID 544 indicates that this record is the second dynamic record in electronic user preference profile 500. Transaction preference 546 indicates that an eighty dollar withdrawal amount has been made with types of currency using 4 twenty dollar bills. In this example, the type of currency used is 4 twenty dollar bills to dispense eighty dollars. Frequency 548 indicates that this type of withdrawal has been performed two times for the user. Pointer 550 points to dynamic record 508.

Dynamic record ID 552 in dynamic record 508 indicates that this record is the third dynamic record within electronic user preference profile 500. Transaction preference 554 indicates a one hundred dollar withdrawal was made using 1 fifty dollar bill, 2twenty dollar bills, and 1 ten dollar bill. This type of currency is in contrast to predefined transaction 532 in predefined transaction profiles 519. The frequency of this transaction is identified as two in frequency 556. Pointer 558 points to dynamic record 510 in which dynamic record identifier 560 indicates that this record is the fourth dynamic record. Transaction preference 562 indicates that a sixty dollar withdrawal amount has been selected by the user for withdrawal of 2 twenty dollar bills and 2ten dollar bills. Frequency 564 indicates that this type of withdrawal has been made two times by the user. Pointer 566 points to dynamic record 512.

Dynamic record ID 568 in dynamic record 512 indicates that this record is the fifth dynamic record in the set of dynamic records. Transaction preference 570 indicates that a twenty dollar withdrawal amount has been made using 1 ten dollar bill and 2 five dollar bills. Frequency 572 indicates that this type of withdrawal has been made two times by the user. Pointer 574 points to end of list 514. End of list 514 indicates that no additional dynamic records are present. Pointer 574 is basically a null pointer. Alternatively, an enumerated or constant variable may be defined to denote end-of-list in lieu of NULL. This variable may be end of list 514.

In these examples, if the set of dynamic records is full when a new dynamic record needs to be added, the least used dynamic record may be discarded and replaced with a new entry. If more than one least recently used dynamic record is present, then one of the records may be selected at random, the last record in the list that has been least recently used may be selected, or some other mechanism may be selected to select one of the records for replacement.

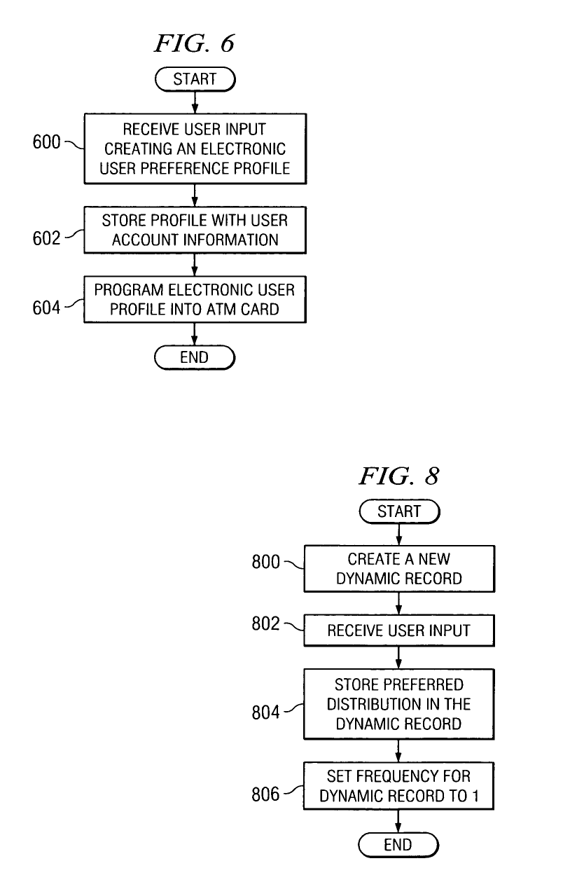

Turning now to FIG. 6, a flowchart of a process for generating an electronic user preference profile is depicted in accordance with an illustrative embodiment of the present invention. The process in FIG. 6 may be implemented in a process, such as profile generation process 400 in FIG. 4. The process in FIG. 6 is typically performed when a user receives a bank card, such as, bank card 408 in FIG. 4. In these examples, bank card 408 in FIG. 4 is an automated teller machine card. This process also may be performed on a current automated teller machine card depending on the particular implementation. Alternatively, the user may input these preferences through a Web supplied tool from the financial institution and either pick up the automated teller machine card or receive the card through the mail.

The process begins by creating an electronic user preference profile by receiving user input (step 600). This profile may be created by a user selecting or inputting preferences as to how the user wishes to receive money or cash when a financial transaction is initiated to withdraw cash or money from the user's account. In these examples, the user may have a primary and secondary preference for the same amounts depending on the particular implementation.

The process then stores the profile with the user account information (step 602). In step 602, the electronic user preference profile is stored in a user account in the banking system in these examples. In this manner, these preferences may be stored for use in generating an automated teller machine card or for creating a new card if one is lost.

Next, the process programs the electronic user preference profile into the automated teller machine card (step 604), with the process terminating thereafter. In this example, the electronic user preference profile is created and programmed into the automated teller machine card from the preferences in the profile as input by the user.

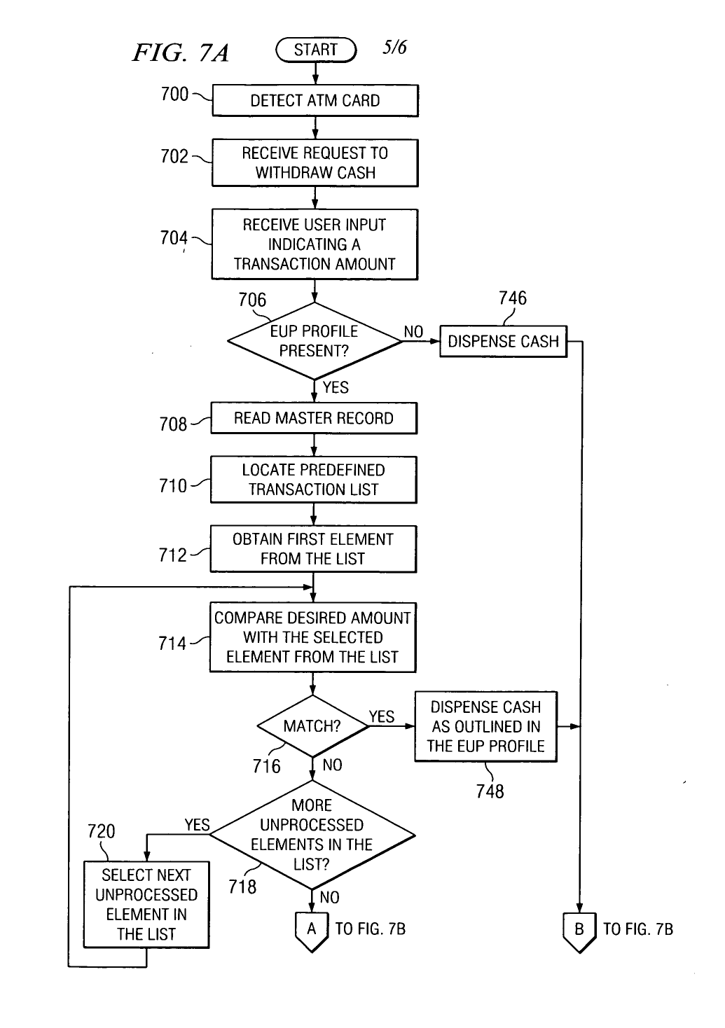

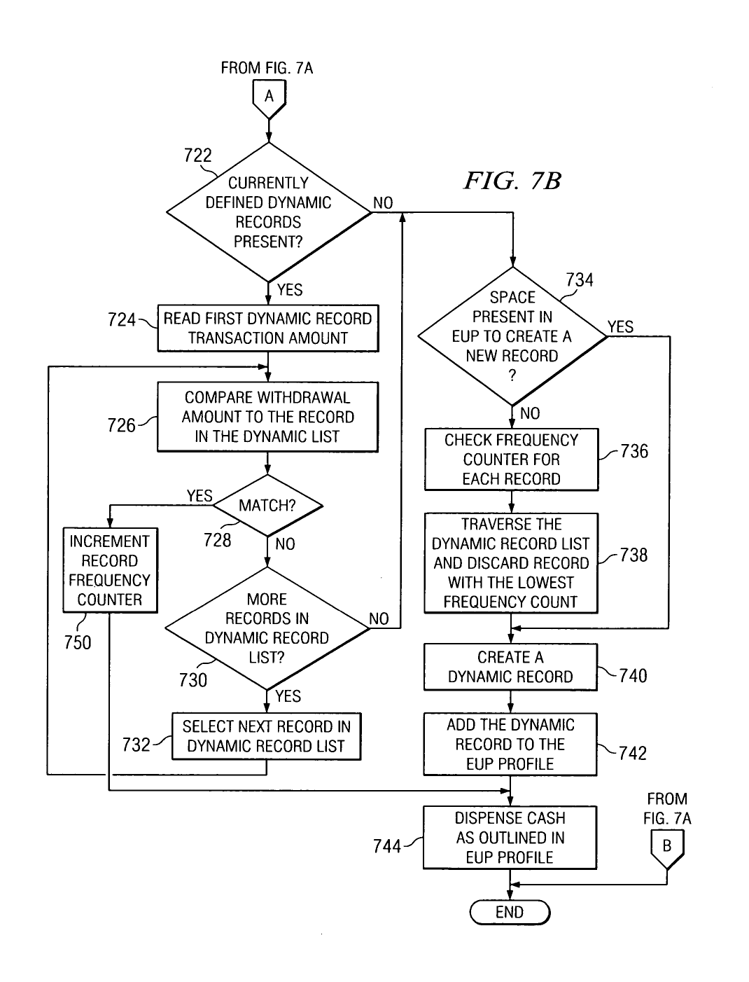

Turning now to FIGS. 7A-7B, a flowchart of a process for processing a financial transaction at an automated teller machine is depicted in accordance with an illustrative embodiment of the present invention. The process in FIGS. 7A-7B may be implemented in a component, such as transaction processing software 410 in FIG. 4.

The process begins by detecting an automated teller machine card (step 700). The process receives a request to withdraw cash from a user account (step 702). The process receives user input indicating a transaction amount (step 704). Next, a determination is made as to whether an electronic user preference (EUP) profile is present on the automated teller machine card (step 706). If an electronic user preference profile is present, the master record in the electronic user preference profile is read (step 708). Then, the predefined transaction list is located (step 710).

The process obtains the first element from the list (step 712), and compares the desired amount input by the user with the selected element from the list (step 714). A determination is made as to whether a match between the desired amount and an amount in the selected element is present (step 716). If a match is not present, a determination is made as to whether more unprocessed elements are present in the list (step 718).

If additional unprocessed elements are present in the list, the process selects the next unprocessed element (step 720). The process then returns to step 714 as described above.

If unprocessed elements are not present in the list, a determination is made as to whether currently defined dynamic records are present in the electronic user preference profile (step 722). If currently defined dynamic records are present in the electronic user preference profile, the process reads the first dynamic record transaction amount (step 724). The process compares the withdrawal amount to the record in the dynamic list (step 726).

Next, a determination is made as to whether a match between the desired amount and the amount in the dynamic record is present (step 728). If a match is not present, a determination is made as to whether more dynamic records are present in the dynamic record list (step 730). If additional records are present in the dynamic record list, the process selects the next record in the dynamic record list (step 732) with the process returning to step 726.

Otherwise, a determination is made as to whether space is present in the electronic user preference profile to create a new record (step 734). If space is not present, the process checks the frequency counter for each record in the dynamic record list (step 736). The process traverses the dynamic record list and discards the record with the lowest frequency count (step 738). Step 738 is performed to remove older records to allow the insertion of newer records when limited space is present. The process creates a dynamic record (step 740). The process then adds the dynamic record to the electronic user preference profile (step 742). The cash is dispensed as outlined for the new record in the profile (step 744), with the process terminating thereafter.

Turning back to step 706, if an electronic user preference profile is not present, the cash is dispensed (step 746), thus ending the process. In step 744, the cash is dispensed in the manner preset for the particular automated teller machine without regard for preferences of the user with the process terminating thereafter. With reference again to step 716, if a match is present, the process dispenses the cash as outlined in the electronic user preference profile (step 748), with the process terminating thereafter.

With reference again to step 722, if the currently defined dynamic records are not present, the process proceeds directly to step 734 as described above. In step 728, if a match is present, the process increments the record frequency counter (step 750), with the process proceeding to step 744 to dispense the cash as outlined in the profile.

With reference again to step 734, if space is present in the electronic user preference profile to create a new record, the process proceeds to step 740 as described above.

Turing now to FIG. 8, a flowchart of a process for creating dynamic records is depicted in accordance with an illustrative embodiment of the present invention. The process in FIG. 8 is a more detailed description of step 740 in FIG. 7.

The process begins by creating a new dynamic record (step 800). The process receives user input (step 802). The process then stores the preferred distribution in the dynamic record (step 804). The process sets the frequency for the dynamic record to 1 (step 806), with the process terminating thereafter.

Thus, the aspects of the present invention provide a computer implemented method, apparatus, and computer usable program code for processing a financial transaction. The aspects of the present invention include receiving a request to perform a financial transaction using a banking card. As illustrated above, this banking card may take various forms, such as, for example, an automated teller machine card with a magnetic stripe, a card containing an embedded circuit, or even a key fob. A determination is made as to whether a profile is present in the banking card.

In these examples, the profile illustrated above is an electronic user preference profile. If this profile is present on the banking card, the financial transaction is performed using the profile to form the completed transaction. In these examples, the profile is used to identify the manner in which cash withdrawals are to be performed.

In this manner, a user may perform banking transactions to withdraw money from an automated teller machine so as to allow the user to receive the withdrawn cash in denominations preferred by the user. This type of withdrawal is enabled even when the automated teller machine does not provide a screen or interface for the user to input these types of preferences into the automated teller machine.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for withdrawing money from a financial institution, the computer implemented method comprising:
receiving a request to withdraw the money using a bank card;
determining whether a profile is present on the bank card; and
responsive to a determination that the profile is present on the bank card, dispensing the money using types of currency based on the profile.

2. The computer implemented method of claim 1 further comprising:
updating the profile based on the types of currency used to dispense the money.

3. The computer implemented method of claim 1, wherein the performing step comprises:
identifying an amount of cash from the request;
identifying a set of preferences for types of currency from the profile; and
dispensing the amount of cash using the types of currency identified from the set of preferences.

4. The computer implemented method of claim 3, wherein the set of preferences is stored in a set of records and wherein the step of identifying a set of preferences comprises:
determining whether a record containing types of currency is present in the set of records.

5. The computer implemented method of claim 1, wherein the bank card is selected from a card having a magnetic bar, a smart card, or a key fob.

6. The computer implemented method of claim 1, wherein the profile stores information about user transactions.

7. The computer implemented method of claim 5, wherein the profile comprises a master record and a plurality of dynamic records.

8. The computer implemented method of claim 6, wherein the master record comprises a header and a set of predefined transaction profiles.

9. The computer implemented method of claim 6, wherein the plurality of dynamic records comprises records of user transactions containing preferences of the user transactions.

10. The computer implemented method of claim 6, wherein each predefined transaction profile in the set of pre-defined transaction profiles defines types of currency for withdrawing a selected amount of money.

11. A computer program product comprising:
a computer usable medium having computer usable program code for withdrawing money from a financial institution, the computer program medium including:
computer usable program code for receiving a request to withdraw the money using a bank card;
computer usable program code for determining whether a profile is present on the bank card; and
computer usable program code, responsive to a determination that the profile is present on the bank card, for dispensing the money using types of currency based on the profile.

12. The computer program product of claim 11 further comprising:
computer usable program code for updating the profile based on the types of currency used to dispense the money.

13. The computer program product of claim 11, wherein computer usable program code, responsive to a determination that the profile is present in the banking card for performing the financial transaction using the profile to form a completed transaction comprises:
computer usable program code for identifying an amount of cash from the request;
computer usable program code for identifying a set of preferences for types of currency from the profile; and
computer usable program code for dispensing the amount of cash using the types of currency identified from the set of preferences.

14. The computer program product of claim 13, wherein the set of preferences is stored in a set of records and wherein the computer usable program code for identifying a set of preferences for types of currency from the profile comprises:
computer usable program code for determining whether a record containing types of currency is present in the set of records.

15. The computer program product of claim 11, wherein the bank card is selected from a card having a magnetic bar, a smart card, or a key fob.

16. The computer program product of claim 11, wherein the profile stores information about user transactions.

17. The computer program product of claim 15, wherein the profile comprises a master record and a plurality of dynamic records.

18. The computer program product of claim 16, wherein the master record comprises a header and a set of predefined transaction profiles.

19. The computer program product of claim 16, wherein the plurality of dynamic records comprises records of user transactions containing preferences of the user transactions.

20. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to receive a request to withdraw the money using a bank card; determines whether a profile is present on the bank card; and dispenses the money using types of currency based on the profile in response to a determination that the profile is present on the banking card.
